(19) United States
(12) Patent Application Publication
(10) Pub. No.: US 2009/0058779 A1
(43) Pub. Date: Mar. 5, 2009

(54) LIQUID CRYSTAL DISPLAY ELEMENT, METHOD OF DRIVING THE SAME, AND ELECTRONIC PAPER INCLUDING THE SAME

(75) Inventors: Toshiaki YOSHIHARA, Kawasaki (JP); Masaki NOSE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/239,993

(22) Filed: Sep. 29, 2008

Related U.S. Application Data
(63) Continuation of application No. PCT/JP2006/306639, filed on Mar. 30, 2006.

(51) Int. Cl. G09G 3/36

(52) U.S. Cl. 345/89; 345/101

(57) ABSTRACT

The prevent invention provides a liquid crystal display element capable of displaying an image in a short time during screen rewriting, a method of driving the same, and an electronic paper including the same. A liquid crystal display element includes: B, G, and R display units that have liquid crystal layers (not shown in FIG. 16) which are driven a predetermined number of driving times to obtain desired grayscales, and display images on the basis of the grayscales; a grayscale conversion control unit (driving control unit) that can determine a driving method on the basis of an external environment; and a driving unit that drives the liquid crystal layers using the determined driving method.

### BACKGROUND

1. Field

The present invention relates to a liquid crystal display element that drives liquid crystal to display an image, a method of driving the same, and an electronic paper including the same.

2. Description of the Related Art

In recent years, many companies and universities actively advance development of electronic papers. Promising fields of application of the electronic paper include the field of an electronic books first of all and include the field of portable apparatus such as sub-displays of mobile terminals and IC card display units or the like. As an example of a display element used for the electronic paper, there is a liquid crystal display element that uses a liquid crystal composition having a cholesteric phase formed therein (which is referred to as cholesteric liquid crystal or chiral nematic liquid crystal and hereinafter, referred to as cholesteric liquid crystal). The cholesteric liquid crystal has, for example, a semipermanent display retention characteristic (memory characteristics), a vivid color display characteristic, a high-contrast characteristic, and a high-resolution characteristic.

FIG. 19 is a cross-sectional view schematically illustrating the structure of a liquid crystal display element 51 capable of performing full color display using the cholesteric liquid crystal. The liquid crystal display element 51 has a structure in which a blue (B) display unit 46b, a green (G) display unit 46g, and a red (R) display unit 46r are laminated from a display surface in this order. In FIG. 19, the outer surface of an upper substrate 47b serves as the display surface, and external light (represented by the arrow in a solid line) is incident on the display surface from the upper side of the substrate 47b. In addition, an observer's eye and a viewing direction (indicated by the arrow in a broken line) are schematically shown above the substrate 47b.

The B display unit 46b includes, a blue (B) liquid crystal 43b interposed between a pair of upper and lower substrates 47b and 49b, and a pulse voltage source 41b that applies a predetermined pulse voltage to the B liquid crystal layer 43b. The G display unit 46g includes, a green (G) liquid crystal 43g interposed between a pair of upper and lower substrates 47g and 49g, and a pulse voltage source 41g that applies a predetermined pulse voltage to the G liquid crystal layer 43g. The R display unit 46r includes, a red (R) liquid crystal 43r interposed between a pair of upper and lower substrates 47r and 49r, and a pulse voltage source 41r that applies a predetermined pulse voltage to the R liquid crystal layer 43r. A light absorbing layer 45 is provided on the rear surface of the lower substrate 49r of the R display unit 46r.

The cholesteric liquid crystal used for each of the B, G, and R liquid crystal layers 43b, 43g, and 43r is a liquid crystal mixture of nematic liquid crystal and a relatively large amount of chiral additive, for example, several tens of percent by weight of additive (which is also called a chiral material). When a relatively large amount of chiral material is added to the nematic liquid crystal, it is possible to form a cholesteric phase having a nematic liquid crystal molecules strongly twisted into a helical shape.

The cholesteric liquid crystal has bistability (memory characteristics) and is possible to be in either of a planar state, a focal conic state, or an intermediate state between the planar state and the focal conic state by adjusting the strength of an electric field applied to the liquid crystal. When the cholesteric liquid crystal is in either of the planar state, the focal conic state, or the intermediate state therebetween once, the cholesteric liquid crystal stably maintains its state even when no electric field is applied.

The planar state is obtained by applying a predetermined high voltage between the upper and lower substrates 47 and 49 to apply a strong electric field to the liquid crystal layer 43 and then rapidly reducing the electric field to zero. The focal conic state is obtained by applying, for example, a predetermined voltage that is lower than the high voltage between the upper and lower substrates 47 and 49 to apply an electric field to the liquid crystal layer 43 and then rapidly reducing the electric field to zero.

The intermediate state between the planar state and the focal conic state is obtained by applying, for example, a voltage that is lower than that used to obtain the focal conic state between the upper and lower substrates 47 and 49 to apply an electric field to the liquid crystal layer 43 and then rapidly reducing the electric field to zero.

Next, the display principle of the liquid crystal display element 51 using the cholesteric liquid crystal will be described using the B display unit 46b as an example. FIG. 20A shows the arrangement of cholesteric liquid crystal molecules 33 in the planar state in the B liquid crystal layer 43b of the B display unit 46b. As shown in FIG. 20A, the liquid crystal molecules 33 in the planar state sequentially rotate in the thickness direction of the substrates to form a helical structure, and the helical axis of the helical structure is substantially vertical to the surfaces of the substrates.

In the planar state, light having a predetermined wavelength corresponding to the helical pitch of the liquid crystal molecules 33 is selectively reflected from the liquid crystal layer. When the average refractive index of the liquid crystal layer is n and the helical pitch is p, a wavelength λ where the highest reflectance is obtained is represented by λ=n·p.

Therefore, in order to selectively reflect blue light from the B liquid crystal layer 43b of the B display unit 46b in the planar state, the average refractive index n and the helical pitch p are determined such that, for example, the wavelength λ is 480 nm. The average refractive index n can be adjusted by selecting a liquid crystal material and a chiral material, and the helical pitch p can be adjusted by adjusting the content of the chiral material.

FIG. 20B shows the arrangement of the cholesteric liquid crystal molecules 33 in the focal conic state in the B liquid crystal layer 43b of the B display unit 46b. As shown in FIG. 20B, the liquid crystal molecules 33 in the focal conic state sequentially rotate in the in-plane direction of the substrates to form a helical structure, and the helical axis of the helical structure is substantially parallel to the surfaces of the substrates. In the focal conic state, the selectivity of the B liquid crystal layer 43b with respect to a reflection wavelength is lost, and the B liquid crystal layer 43b transmits most of incident light. The transmitted light is absorbed by the light absorbing layer 45 that is provided on the rear surface of the lower substrate 49r of the R display unit 46r whereby dark (black) display is achieved.

In the intermediate state between the planar state and the focal conic state, the ratio of the reflected light and the transmitted light is adjusted by the ratio of the planar state and the focal conic state, and the intensity of the reflected light varies. Therefore, it is possible to perform halftone display corresponding to the intensity of the reflected light.

As described above, it is possible to control the amount of light reflected by the alignment state of the cholesteric liquid crystal molecules 33 twisted in the helical shape. Similar to the B liquid crystal layer 43b described above, the cholesteric liquid crystal that selectively reflects green and red light in the planar state is injected into the G liquid crystal layer 43g and the R liquid crystal layer 43r to manufacture the liquid crystal display element 51 capable of performing full color display. The liquid crystal display element 51 has memory characteristics and can perform full color display without consuming power except screen rewriting.

Patent Document 1: JP-A-2002-14324

Patent Document 2: JP-A-2004-117404

However, the time required for the liquid crystal display element using the cholesteric liquid crystal to perform data write scanning for screen rewriting is 10 to 100 times longer than that in a liquid crystal display element according to the related art using twisted nematic (TN) liquid crystal or super twisted nematic (STN) liquid crystal. Therefore, about 0.5 to 10 seconds are required to perform screen rewriting, and it takes a long time to perform screen rewriting. In particular, the response characteristics of liquid crystal are lowered at a low temperature, and it takes further a long time to perform screen rewriting.

### SUMMARY OF THE INVENTION

According to an aspect of the invention, there is a liquid crystal display element including, a display unit that includes liquid crystal; a driving control unit that can determine a driving method on the basis of an external environment; and a driving unit that drives the liquid crystal using the determined driving method.

### BRIEF DESCRIPTION OF THE DRAWINGS

FIG. 1 is a diagram schematically illustrating the structure of a liquid crystal display element 1 according to a first embodiment;

FIG. 2 is a cross-sectional view schematically illustrating the structure of the liquid crystal display element 1 according to the first embodiment;

FIG. 3 is a diagram illustrating an example of the reflection spectrum of the liquid crystal display element in a planar state;

FIGS. 4A and 4B are diagrams illustrating examples of the driving waveforms of the liquid crystal display element 1 according to the first embodiment;

FIG. 5 is a diagram illustrating an example of a voltage-reflectance characteristic of cholesteric liquid crystal;

FIG. 6 is a graph illustrating a cumulative response characteristic of the cholesteric liquid crystal;

FIG. 7 is a diagram illustrating a process of displaying level 7 (blue) in a multi-tone display method according to the first embodiment;

FIG. 8 is a diagram illustrating a process of displaying level 6 in the multi-tone display method according to the first embodiment;

FIG. 9 is a diagram illustrating a process of displaying level 5 in the multi-tone display method according to the first embodiment;

FIG. 10 is a diagram illustrating a process of displaying level 4 in the multi-tone display method according to the first embodiment;

FIG. 11 is a diagram illustrating a process of displaying level 3 in the multi-tone display method according to the first embodiment;

FIG. 12 is a diagram illustrating a process of displaying level 2 in the multi-tone display method according to the first embodiment;

FIG. 13 is a diagram illustrating a process of displaying level 1 in the multi-tone display method according to the first embodiment;

FIG. 14 is a diagram illustrating a process of displaying level 0 (black) in the multi-tone display method according to the first embodiment;

FIG. 15 is a graph illustrating the relationship between a screen rewriting time of the liquid crystal display element 1 and the temperature when the multi-tone display method according to the first embodiment is used;

FIG. 16 is a system block diagram illustrating an image processing method of the liquid crystal display element 1 according to the first embodiment;

FIG. 17 is a system block diagram illustrating an image processing method of the liquid crystal display element 1 according to the related art, which is a comparative example of the image processing method of the liquid crystal display element 1 according to the first embodiment;

FIG. 18 is a system block diagram illustrating an image processing method of a liquid crystal display element 101 according to a second embodiment;

FIG. 19 is a cross-sectional view schematically illustrating the structure of a liquid crystal display element according to related art that is capable of performing full color display; and

FIGS. 20A and 20B are cross-sectional views schematically illustrating the structure of a liquid crystal layer of the liquid crystal display element according to the related art.

### DESCRIPTION OF THE PREFERRED EMBODIMENTS

### First Embodiment

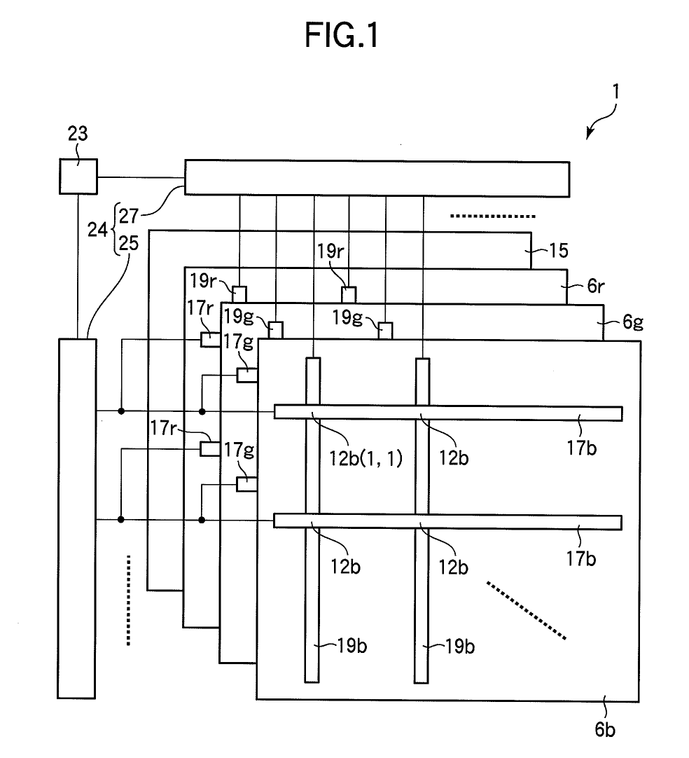

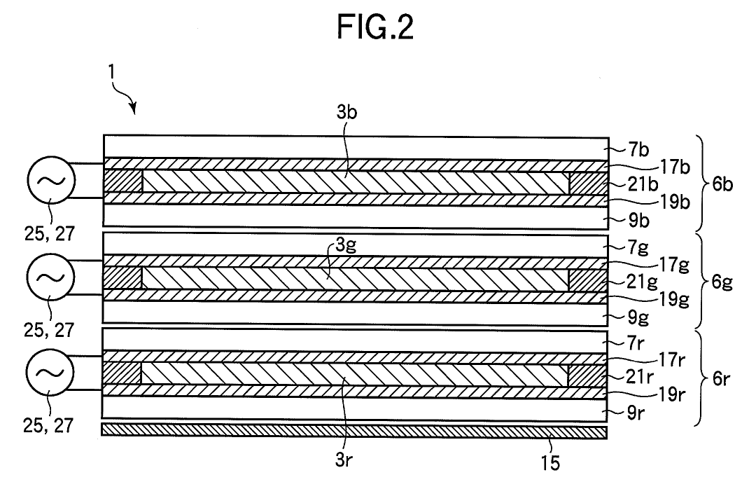

A liquid crystal display element, a method of driving the same, and an electronic paper including the same according to a first embodiment will be described with reference to FIGS. 1 to 17. In this embodiment, a liquid crystal display element 1 using blue (B), green (G), and red (R) cholesteric liquid crystals is used as an example of a liquid crystal display element. FIG. 1 is a diagram schematically illustrating an example of the structure of the liquid crystal display element 1 according to this embodiment. FIG. 2 is a cross-sectional view schematically illustrating the structure of the liquid crystal display element 1 taken along a line that is parallel to the horizontal direction of FIG. 1.

As shown in FIGS. 1 and 2, the liquid crystal display element 1 include a B display unit (first display unit) 6b having a B liquid crystal layer 3b that reflects blue light in a planar state, a G display unit (second display unit) 6g having a G liquid crystal layer 3g that reflects green light in a planar state, and an R display unit (third display unit) 6r having an R liquid crystal layer 3r that reflects red light in a planar state. The B, G, and R display units 6b, 6g, and 6r are laminated in this order from a light incident surface (display surface).

The B display unit 6b includes a pair of upper and lower substrates 7b and 9b opposite to each other and the B liquid crystal layer 3b that is sealed between the two substrates 7b and 9b. The B liquid crystal layer 3b includes B cholesteric liquid crystal having an average refractive index n and a helical pitch p that are adjusted so as to selectively reflect blue light.

The G display unit 6g includes a pair of upper and lower substrates 7g and 9g opposite to each other and the G liquid crystal layer 3g that is sealed between the two substrates 7g and 9g. The G liquid crystal layer 3g includes G cholesteric liquid crystal having an average refractive index n and a helical pitch p that are adjusted so as to selectively reflect green light.

The R display unit 6r includes a pair of upper and lower substrates 7r and 9r opposite to each other and the R liquid crystal layer 3r that is sealed between the two substrates 7r and 9r. The R liquid crystal layer 3r includes R cholesteric liquid crystal having an average refractive index n and a helical pitch p that are adjusted so as to selectively reflect red light.

A liquid crystal composition forming the B, G, and R liquid crystal layers 3b, 3g, and 3r is cholesteric liquid crystal obtained by adding 10 to 40 wt % of chiral material to a nematic liquid crystal mixture. The content of the chiral material added is represented by a value when the sum of the amount of nematic liquid crystal component and the amount of chiral material is 100 wt %. Various kinds of known liquid crystal materials may be used as the nematic liquid crystal.

However, it is preferable to use nematic liquid crystal having dielectric anisotropy Δε in a range of 20≦Δε≦50 in order to relatively reduce a driving voltage for the liquid crystal layers 3b, 3g, and 3r. In addition, the refractive index anisotropy Δn of the cholesteric liquid crystal is preferably in a range of 0.18≦Δn≦0.24. When the refractive index anisotropy Δn is smaller than the above-mentioned range, the reflectances of the liquid crystal layers 3b, 3g, and 3r in the planar state are lowered. On the other hand, in the case in which the refractive index anisotropy Δn is larger than the above-mentioned range, as the scatter reflections of the liquid crystal layers 3b, 3g, and 3r in a focal conic state increase, the viscosities of the liquid crystal layers 3b, 3g, and 3r increase, which results in a low response speed.

The chiral material added to the B and R cholesteric liquid crystals and the chiral material added to the G cholesteric liquid crystal are optical isomers having different optical rotatory powers. Therefore, the B and R cholesteric liquid crystals have the same optical rotatory power, but the optical rotatory powers of the B and R cholesteric liquid crystals are different from that of the G cholesteric liquid crystal.

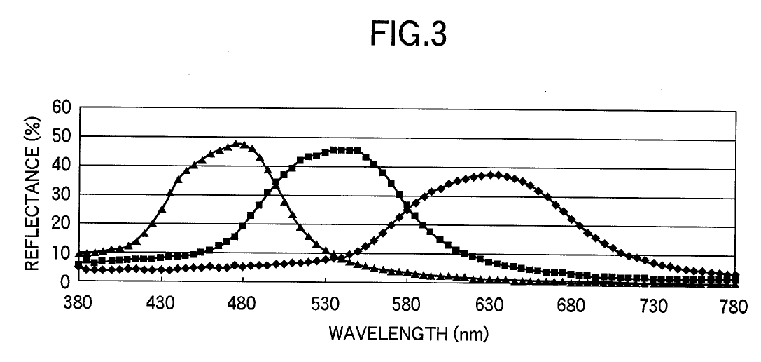

FIG. 3 is a diagram illustrating an example of a reflectance spectrum of each of the liquid crystal layers 3b, 3g, and 3r in the planar state. In FIG. 3, the horizontal axis indicates the wavelength (nm) of reflected light, and the vertical axis indicates reflectance (with respect to a white plate; %). The reflectance spectrum of the B liquid crystal layer 3b is represented by a curved line linking symbols ▴ in FIG. 3. Similarly, the reflectance spectrum of the G liquid crystal layer 3g is represented by a curved line linking symbols ▪, and the reflectance spectrum of the R liquid crystal layer 3r is represented by a curved line linking symbols ♦.

As shown in FIG. 3, in the reflectance spectrums of the liquid crystal layers 3b, 3g, and 3r in the planar state, the liquid crystal layer 3b has the longest center wavelength, followed by the liquid crystal layers 3g and 3r. In the laminated structure of the B, G, and R display units 6b, 6g, and 6r, the optical rotatory power of the G liquid crystal layer 3g is different from the optical rotatory powers of the B and R liquid crystal layers 3b and 3r in the planar state. Therefore, in an overlap region between blue light and green light and an overlap region between green light and red light in the reflectance spectrum shown in FIG. 3, for example, the B liquid crystal layer 3b and the R liquid crystal layer 3r can reflect right circularly polarized light, and the G liquid crystal layer 3g can reflect left circularly polarized light. In this way, it is possible to reduce the loss of reflected light and thus improve the brightness of a display screen of the liquid crystal display element 1.

The upper substrates 7b, 7g, and 7r and the lower substrates 9b, 9g, and 9r need to be transmissive. In this embodiment, two polycarbonate (PC) film substrates each having a size of 10 (cm)×8 (cm) are used. Instead of the PC substrates, glass substrates or polyethylene terephthalate (PET) film substrates may be used. These film substrates have sufficient flexibility. In this embodiment, all of the upper substrates 7b, 7g, and 7r and the lower substrates 9b, 9g, and 9r can transmit light. However, the lower substrate 9r of the R display unit 6r, which is arranged at the lowermost layer, may not transmit light.

As shown in FIGS. 1 and 2, a plurality of strip-shaped data electrodes 19b are formed in parallel to each other on one surface of the lower substrate 9b of the B display unit 6b facing the B liquid crystal layer 3b so as to extend in the vertical direction of FIG. 1. In addition, in FIG. 2, reference numeral 19b denotes a region in which the plurality of data electrodes 19b are arranged. Further, a plurality of strip-shaped scanning electrodes 17b are formed in parallel to each other on one surface of the upper substrate 7b facing the B liquid crystal layer 3b so as to extend in the horizontal direction of FIG. 1. As shown in FIG. 1, the plurality of scanning electrodes 17b and the plurality of data electrode 19b are opposite to each other such that they intersect each other, as viewing the upper and lower substrates 7b and 9b in the normal direction of the electrode-formed surface. In this embodiment, in order to support a 240×320 QVGA resolution, transparent electrodes are patterned to form 240 strip-shaped scanning electrodes 17b and 320 strip-shaped data electrodes 19b at a pitch of 0.24 mm. Intersections of the electrodes 17b and the electrodes 19b serve as B pixels 12b. A plurality of B pixels 12b are arranged in a matrix of 240 rows×320 columns.

Similar to the B display unit 6b, the G display unit 6g is provided with 240 scanning electrodes 17g, 320 data electrodes 19g, and G pixels 12g (not shown) that are arranged in a matrix of 240 rows by 320 columns. Similarly, the R display unit 6r is provided with scanning electrodes 17r, data electrodes 19r, and R pixels 12r (not shown). A set of the B, G, and R pixels 12b, 12g, and 12r forms one pixel 12 of the liquid crystal display element 1. The pixels 12 are arranged in a matrix to form a display screen.

The scanning electrodes 17b, 17g, and 17r and the data electrodes 19b, 19g, and 19r are typically formed of, for example, an indium tin oxide (ITO). These electrodes may be formed of a film of a transparent conductive material, such as an indium zinc oxide (IZO), amorphous silicon, or bismuth silicon oxide (BSO), or a metallic material, such as aluminum or silicon.

A scanning electrode driving circuit 25 having a scanning electrode driver IC for driving a plurality of scanning electrodes 17b, 17g, and 17r is connected to the upper substrates 7b, 7g, and 7r. In addition, a data electrode driving circuit 27 having a data electrode driver IC for driving a plurality of data electrodes 19b, 19g, and 19r is connected to the lower substrates 9b, 9g, and 9r. The scanning electrode driving circuit 25 and the data electrode driving circuit 27 form a driving unit 24.

The scanning electrode driving circuit 25 selects predetermined three scanning electrodes 17b, 17g, and 17r on the basis of predetermined signals output from the control circuit 23, and simultaneously outputs scanning signals to the selected three scanning electrodes 17b, 17g, and 17r. Meanwhile, the data electrode driving circuit 27 outputs image data signals corresponding to the B, G, and R pixels 12b, 12g, and 12r on the selected scanning electrode 17b, 17g, and 17R to the data electrodes 19b, 19g, and 19r, on the basis of predetermined signals output from the control circuit 23. For example, general-purpose STN driver ICs having a TCP (tape carrier package) structure are used as the scanning electrode driver IC and the data electrode driver IC.

In this embodiment, driving voltages for the B, G, and R liquid crystal layers 3b, 3g, and 3r can be substantially equal to each other. Therefore, each input terminals of the scanning electrodes 17b, 17g, and 17r are commonly connected to a predetermined output terminal of the scanning electrode driving circuit 25. In this way, it is not necessary to provide the scanning electrode driving circuit 25 for each of the B, G, and R display units 6b, 6g, and 6r, and thus it is possible to simplify the structure of a driving circuit of the liquid crystal display element 1. In addition, it is possible to reduce the number of scanning electrode driver ICs and thus reduce the manufacturing costs of the liquid crystal display element 1. The output terminals of the B, G, and R scanning electrode driving circuit 25 may be made in common, if necessary.

It is preferable that a functional film, such as an insulating film (not shown) or an alignment film (not shown) that controls the alignment of liquid crystal molecules, be coated on each of the two electrodes 17b and 19b. The insulating film prevents a short circuit between the electrodes 17b and 19b, and serves as a gas barrier layer to improve the reliability of the liquid crystal display element 1. In addition, the alignment film may be formed of an organic material, such as polyimide resin, polyamid-imide resin, polyetherimide resin, polyvinylbutiral resin, or acrylic resin, or an inorganic material, such as silicon oxide or aluminum oxide. In this embodiment, for example, alignment films are formed (coated) on the entire surfaces of the substrates on the electrodes 17b and 19b. The alignment films may also serve as the insulating films.

As shown in FIG. 2, the B liquid crystal layer 3b is sealed between the two substrates 7b and 9b by a sealing material 21b that is applied onto the edges of the upper and lower substrates 7b and 9b. In addition, it is necessary to maintain the thickness (cell gap) d of the B liquid crystal layer 3b to be uniform. In order to maintain a predetermined cell gap d, a plurality of spherical spacers formed of resin or an inorganic oxide are dispersed in the B liquid crystal layer 3b, or a plurality of pillar spacers are dispersed in the B liquid crystal layer 3b. In the liquid crystal display element 1 according to this embodiment, spacers (not shown) are inserted into the B liquid crystal layer 3b to maintain a uniform cell gap d. The cell gap d of the B liquid crystal layer 3b preferably satisfies 3 μm≦d≦6 μm. If the cell gap d is smaller than this range, the reflectance of the B liquid crystal layer 3b in the planar state is lowered, and the cell gap d larger than this range requires an excessively high driving voltage.

Since the G display unit 6g and the R display unit 6r have the same structure as the B display unit 6b, a description thereof will be omitted. A visible light absorbing layer 15 is provided on the outer surface (rear surface) of the lower substrate 9r of the R display unit 6r. The visible light absorbing layer 15 can effectively absorb light not reflected from the B, G, and R liquid crystal layers 3b, 3g, and 3r. Therefore, the liquid crystal display element 1 can display an image with a high contrast ratio. The visible light absorbing layer 15 may be optionally provided.

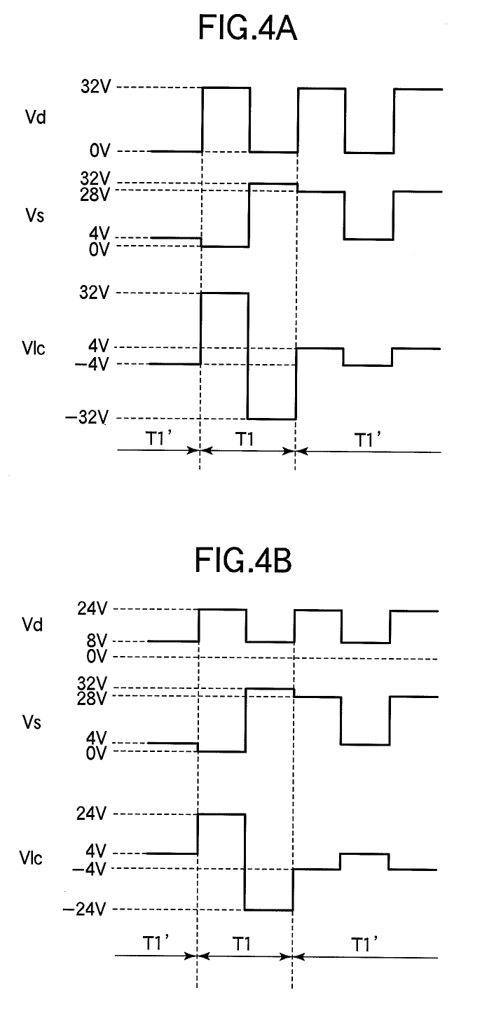

Next, a method of driving the liquid crystal display element 1 will be described with reference to FIGS. 4A to 17. FIGS. 4A and 4B are diagrams illustrating examples of the driving waveforms of the liquid crystal display element 1. FIG. 4A shows a driving waveform for changing the cholesteric liquid crystal to a planar state, and FIG. 4B shows a driving waveform for changing the cholesteric liquid crystal to a focal conic state. In FIGS. 4A and 4B, an upper part shows a data signal voltage waveform Vd that is output from the data electrode driving circuit 27, a middle part shows a scanning signal voltage waveform Vs that is output from the scanning electrode driving circuit 25, and a lower part shows a voltage waveform Vlc that is applied to the pixels 12b, 12g, and 12r of the B, G, and R liquid crystal layers 3b, 3g, and 3r. In addition, in FIGS. 4A and 4B, the horizontal direction indicates the time elapsed, and the vertical direction indicates a voltage.

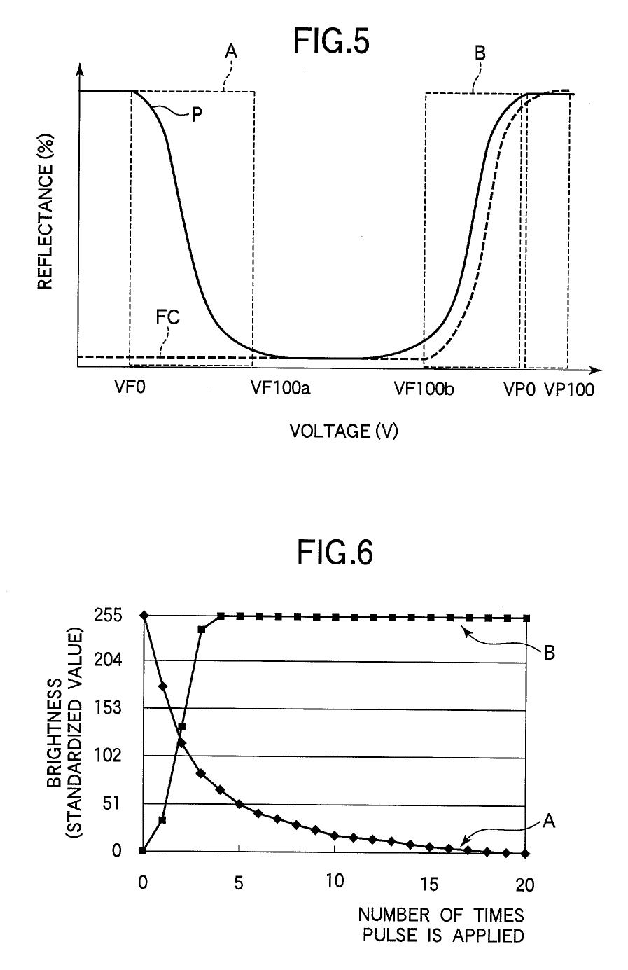

FIG. 5 is a diagram illustrating an example of the voltage-reflectance characteristic of the cholesteric liquid crystal. The horizontal axis indicates a voltage (V) applied to the cholesteric liquid crystal, and the vertical axis indicates the reflectance (%) of the cholesteric liquid crystal. In FIG. 5, a solid curved line P indicates the voltage-reflectance characteristic of the cholesteric liquid crystal whose initial state is a planar state, and a broken curved line FC indicates the voltage-reflectance characteristic of the cholesteric liquid crystal whose initial state is a focal conic state.

Here, an example in which a predetermined voltage is applied to a blue (B) pixel 12b(1, 1) arranged at an intersection of the first column data electrode 19b and the first row scanning electrode 17b of the B display unit 6b shown in FIG. 1 will be described. As shown in FIG. 4A, in the first half period of a selection period T1 for which the first row scanning electrode 17b is selected, a data signal voltage Vd becomes +32 V and a scanning signal voltage Vs becomes 0 V. In the second half period of the selection period, the data signal voltage Vd becomes 0 V and the scanning signal voltage becomes +32 V. Therefore, a pulse voltage of ±32 V is applied to the B liquid crystal layer 3b of the B pixel 12b(1, 1) during the selection period T1. As shown in FIG. 5, when a predetermined high voltage VP100 (for example, 32 V) is applied to the cholesteric liquid crystal to generate a strong electric field, the liquid crystal molecules having a helical structure are completely untwisted, and all the liquid crystal molecules are arranged in a homeotropic state along the direction of the electric field. Therefore, the liquid crystal molecules in the B liquid crystal layer 3b of the B pixel 12b(1, 1) are in the homeotropic state during the selection period T1.

During a non-selection period T1′ after the selection period T1, a voltage of, for example, +28 V or +4 V is applied to the first row scanning electrode 17b in a period corresponding to half the selection period T1. Meanwhile, a predetermined data signal voltage Vd is applied to the first column data electrode 19b. In FIG. 4A, a voltage of, for example, +32 V or 0 V is applied to the first column data electrode 19b in a period corresponding to half the selection period T1. Therefore, a pulse voltage of ±4 V is applied to the B liquid crystal layer 3b of the B pixel 12b(1, 1) during the non-selection period T1′. In this way, the electric field generated in the B liquid crystal layer 3b of the B pixel 12b(1, 1) during the non-selection period T1′ becomes approximately zero.

When the voltage applied to the liquid crystal molecules in the homeotropic state is changed from VP100 (±32 V) to VF0 (±4 V) and the electric field is sharply reduced to approximately zero, the liquid crystal molecules are helically twisted such that their helical axes are aligned with a direction that is substantially vertical to the two electrodes 17b and 19b, and turn to the helical state, which is the planar state that selectively reflects light corresponding to a helical pitch. Therefore, the B liquid crystal layer 3b of the B pixel 12b(1, 1) turns to the planar state to reflect light. As a result, the B pixel 12b(1, 1) displays blue.

Meanwhile, as shown in FIG. 4B, about in the first half period and the second half period of the selection period T1, the data signal voltage Vd becomes 24 V/8 V and the scanning signal voltage Vs becomes 0 V/+32 V. Then, a pulse voltage of ±24 V is applied to the B liquid crystal layer 3b of the B pixel 12b(1, 1). As shown in FIG. 5, when a predetermined low voltage VF100b (for example, 24 V) is applied to the cholesteric liquid crystal to generate a weak electric field, a helical structure of the liquid crystal molecule is not completely untwisted. During the non-selection period T1′, a voltage of, for example, +28 V/+4 V is applied to the first row scanning electrode 17b in a period corresponding to half the selection period T1, and a predetermined data signal voltage Vd (for example, +24 V/8 V) is applied to the data electrode 19b in a period corresponding to half the selection period T1. Therefore, a pulse voltage of −4 V/+4 V is applied to the B liquid crystal layer 3b of the B pixel 12b(1, 1) during the non-selection period T1′. In this way, the electric field generated in the B liquid crystal layer 3b of the B pixel 12b(1, 1) during the non-selection period T1′ becomes approximately zero.

In the state in which the liquid crystal molecules having the helical structure are not completely untwisted, when the voltage applied to the cholesteric liquid crystal is changed from VF100b (±24 V) to VF0 (±4 V) and the electric field is rapidly reduced to approximately zero, the liquid crystal molecules are helically twisted such that their helical axes are aligned with a direction that is substantially parallel to the two electrodes 17b and 19b, and turn to the focal conic state that transmits incident light. Therefore, the B liquid crystal layer 3b of the B pixel 12b(1, 1) becomes the focal conic state and transmits light. As shown in FIG. 5, even when a voltage of VP100 (V) is applied to generate a strong electric field in the liquid crystal layer and then the electric field is slowly removed, it is possible to maintain the cholesteric liquid crystal in the focal conic state.

Further, in this embodiment, multi-tone display is performed by using cumulative response characteristics of the cholesteric liquid crystal. When a pulse voltage is applied to the cholesteric liquid crystal plural times, it is possible to change the cholesteric liquid crystal from the planar state to the focal conic state or from the focal conic state to the planar state using the cumulative response characteristics.

FIG. 6 is a graph illustrating the cumulative response characteristics of the cholesteric liquid crystal. The horizontal axis indicates the number of times a pulse voltage is applied to the cholesteric liquid crystal, and the vertical axis indicates brightness, which is a standardized value. In this case, a brightness value is 0 when the cholesteric liquid crystal is in the focal conic state, and a brightness value is 255 when the cholesteric liquid crystal is in the planar state. In FIG. 6, a curved line A linking symbols ♦ indicates the relationship between the brightness and the number of times a predetermined pulse voltage in the range represented by a broken line rectangle A in FIG. 5 (a halftone region A) is applied to the cholesteric liquid crystal in the planar state. In FIG. 6, a curved line B linking symbols ▪ indicates the relationship between the brightness and the number of times a predetermined pulse voltage in the range represented by a broken line rectangle B in FIG. 5 (a halftone region B) is applied to the cholesteric liquid crystal.

As represented by the curved line A in FIG. 6, when the initial state of the cholesteric liquid crystal is a planar state and a predetermined pulse voltage in the halftone region A of FIG. 5 is continuously applied to the cholesteric liquid crystal, the state of the cholesteric liquid crystal is changed from the planar state (brightness value: 255) to the focal conic state (brightness value: 0) according to the number of times the pulse voltage is applied. As represented by the curved line B in FIG. 6, when a predetermined pulse voltage in the halftone region B of FIG. 5 is continuously applied to the cholesteric liquid crystal, the state of the cholesteric liquid crystal is changed from the focal conic state (brightness value: 0) to the planar state (brightness value: 255) according to the number of times the pulse voltage is applied, regardless of the initial state of the cholesteric liquid crystal. Therefore, it is possible to display a desired grayscale by adjusting the number of times a pulse voltage is applied.

As shown in FIG. 6, the brightness value varies from 0 to 255 more slowly in the curved line A than in the curved line B. Therefore, for multi-tone display, it is more preferable to use the cumulative response of the halftone region A shown in FIG. 5 to obtain high color reproducibility at a high gray-scale level and color uniformity than to use the cumulative response of the halftone region B. Accordingly, this embodiment uses a multi-tone display method using the cumulative response of the cholesteric liquid crystal in the halftone region A.

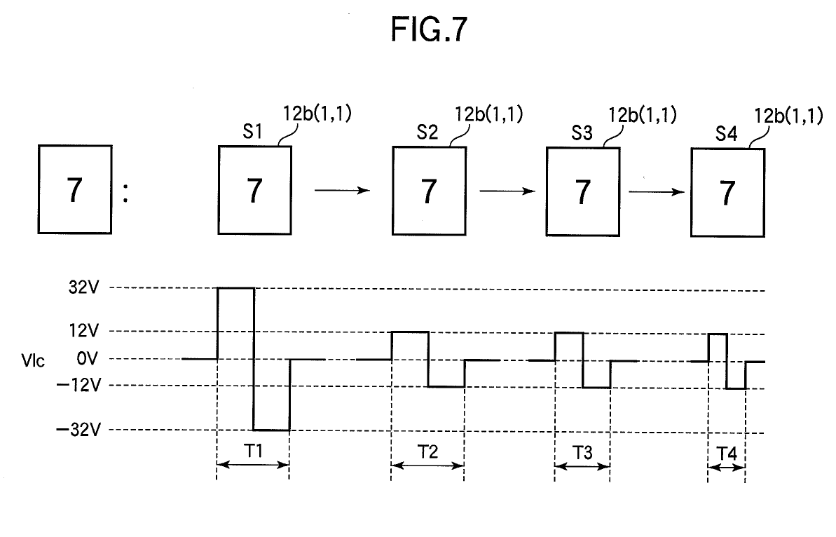

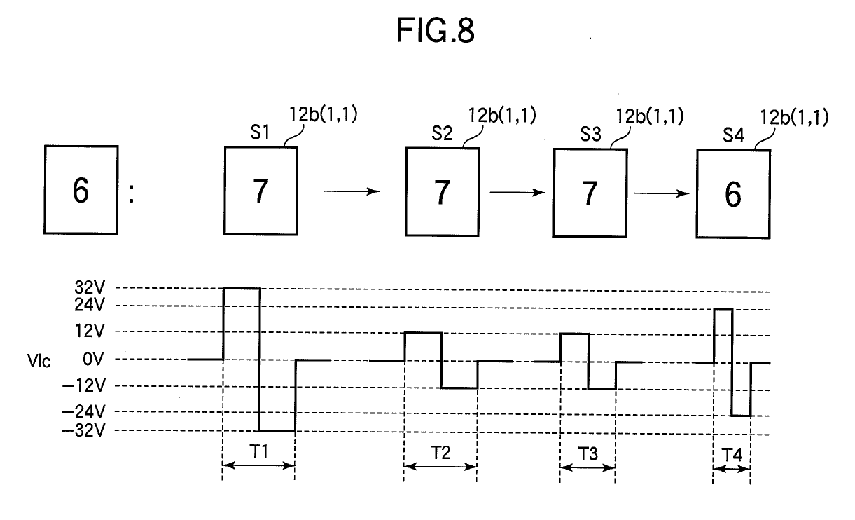

Next, a detailed method of multi-tone display according to this embodiment will be described with reference to FIGS. 7 to 14. Hereinafter, an example in which the blue (B) pixel 12b(1, 1) performs display at any one of 8 grayscale levels from level 7 (blue) to level 0 (black) will be described. At grayscale level 7, the cholesteric liquid crystal in the pixel is in the planar state and has high reflectance. At grayscale level 0, the cholesteric liquid crystal is in the focal conic state and has low reflectance. FIG. 7 shows a process of making the grayscale of the B pixel 12b(1, 1) at the level 7 (blue). Similarly, FIGS. 8 to 14 show processes of making the grayscale of the pixel at levels 6 to 0, respectively.

In FIGS. 7 to 14, a rectangle on the upper left side schematically illustrates the outer appearance of the B pixel 12b(1, 1), and the value in the rectangle indicates a desired grayscale level. In addition, cumulative response processing steps of obtaining the desired grayscale level of the B pixel 12b(1, 1) are shown on the right side of the rectangle together with arrows indicating the steps in time series and a variation in the grayscale level in the pixel. In FIGS. 7 to 14, a lower part shows a pulse voltage Vlc that is applied to the B pixel 12b(1, 1) in each of the cumulative response processing steps.

As shown in the drawings, in this embodiment, cumulative response processing is performed in four steps from Step S1 to Step S4. In step S1, a pulse voltage Vlc corresponding to the level 7 or the level 0 is applied for an application time T1 (=2.0 ms). As shown in FIGS. 7 to 13, when a desired grayscale level is any one of the level 7 and the levels 6 to 1 (halftone), a pulse voltage Vlc of ±32 V is applied, as described above with reference to FIG. 4A. In this way, it is possible to change the cholesteric liquid crystal to the planar state in advance in order to use the cumulative response in the halftone region A shown in FIG. 5.

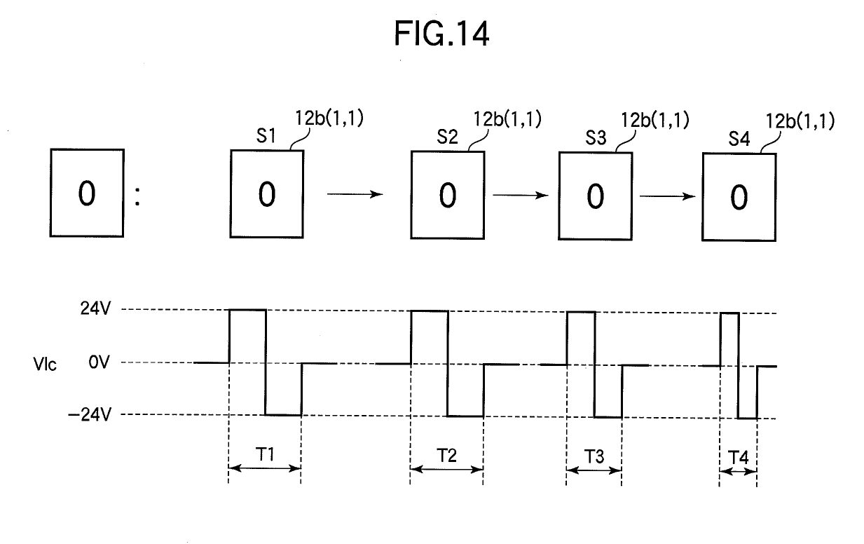

Further, as shown in FIG. 14, when a desired grayscale level is the level 0, in Step S1, a pulse voltage Vlc of ±24 V is applied, as described above with reference to FIG. 4B. At the level 0, it is not necessary to use the cumulative response. Therefore, in Step S1, it is possible to make the cholesteric liquid crystal in the focal conic state.

Then, in Steps S2 to S4, a predetermined pulse voltage Vlc is applied for predetermined application times T2 to T4. As shown in FIGS. 7 to 14, in Steps S2 to S4, a pulse voltage Vlc having a level capable of changing the cholesteric liquid crystal from the planar state to the focal conic state using the cumulative response in the halftone region A or a pulse voltage Vlc having a level capable of maintaining the state of the cholesteric liquid crystal without changing the state is applied. In this embodiment, a pulse voltage of ±24 V is applied to change the cholesteric liquid crystal from the planar state to the focal conic state. In addition, a pulse voltage of ±12 V is applied to maintain the state of the cholesteric liquid crystal without changing the state.

In Steps S2 to S4, the application times T2 to T4 of the pulse voltage are different from each other. It is possible to change the state of the cholesteric liquid crystal by changing the pulse width of a pulse voltage applied as well as by changing the level of a pulse voltage applied. In the halftone region A shown in FIG. 5, it is possible to change the cholesteric liquid crystal to the focal conic state by changing the pulse width of a pulse voltage applied so as to be larger. In this embodiment, a pulse voltage application time T2 is set to 2.0 ms in Step S2, a pulse voltage application time T3 is set to 1.5 ms in Step S3, and a pulse voltage application time T4 is set to 1.0 ms in Step S4.

It is possible to control the pulse voltage application times T1 to T4 by lowering the frequency of clocks for driving the scanning electrode driving circuit 25 and the data electrode driving circuit 27 to lengthen an output period. In order to stably switch the pulse width, it is more preferable to logically change the division ratio of a clock generating unit that generates a clock input to a driver than to change the clock frequency in an analog manner.

In this way, 2³ (=8) driving patterns are obtained by a combination of two kinds of pulse voltages (±24 V and ±12 V) and three kinds of pulse widths (2.0 ms, 1.5 ms, and 1.0 ms) that are arranged in time series. Table 1 shows the above-mentioned driving patterns. Specifically, Table 1 shows the pulse width (the period for which the pulse voltage is applied) (ms) of the pulse voltage applied to the B pixel 12b(1, 1) in Steps S1 to S4 and the level (V) of the pulse voltage applied in Steps S1 to S4 for each of the grayscale levels 7 (blue) to 0 (black).

TABLE 1

| | | | |
|---|---|---|---|
| S1 | S2 | S3 | S4 |

Application time

| | 2.0 ms | 2.0 ms | 1.5 ms | 1.0 ms |
|---|---|---|---|---|
| Level 7 (blue) | ±32 V | ±12 V | ±12 V | ±12 V |
| Level 6 | ±32 V | ±12 V | ±12 V | ±24 V |
| Level 5 | ±32 V | ±12 V | ±24 V | ±12 V |
| Level 4 | ±32 V | ±12 V | ±24 V | ±24 V |
| Level 3 | ±32 V | ±24 V | ±12 V | ±12 V |
| Level 2 | ±32 V | ±24 V | ±12 V | ±24 V |
| Level 1 | ±32 V | ±24 V | ±24 V | ±12 V |
| Level 0 (black) | ±24 V | ±24 V | ±24 V | ±24 V |

In order to make the grayscale of the B pixel 12b(1, 1) at level 7 (blue), as shown in Table 1 and FIG. 7, a pulse voltage Vlc of +12 V is applied to the cholesteric liquid crystal in Steps S2 to S4. In Step S1, a pulse voltage Vlc of ±32 V has already been applied to change the cholesteric liquid crystal to the planar state, thereby obtaining the grayscale level 7. Therefore, in Steps S2 to S4, a pulse voltage Vlc of ±12 V is applied to maintain the previous state, thereby making the grayscale of the pixel at the level 7.

In order to make the grayscale of the B pixel 12b(1, 1) at level 6, as shown in Table 1 and FIG. 8, in Steps S2 and S3, a pulse voltage Vlc of ±12 V is applied to the cholesteric liquid crystal to maintain the planar state (level 7) up to Step S3. Then, in the next Step S4, a pulse voltage Vlc of ±24 V is applied to the cholesteric liquid crystal for a time of 1.0 ms to change the state of the cholesteric liquid crystal close to the focal conic state by a predetermined amount, thereby obtaining the grayscale level 6 that is one level lower than the level 7.

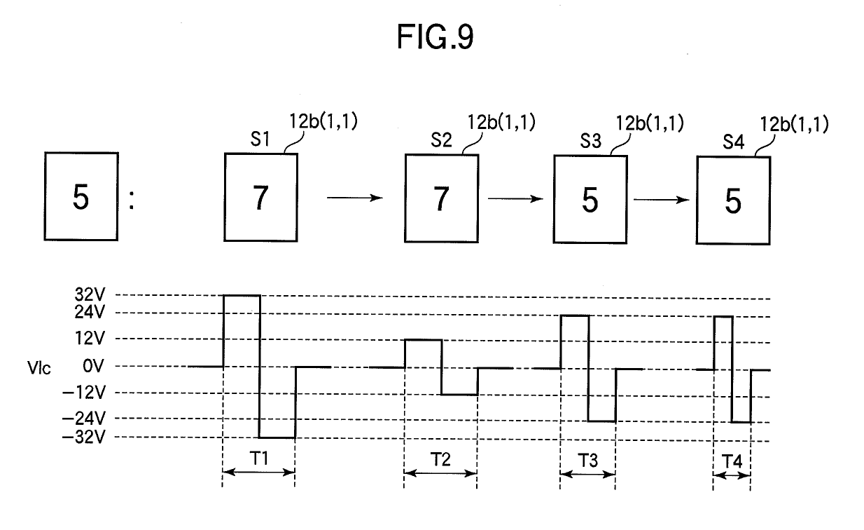

In order to make the grayscale of the B pixel 12b(1, 1) at level 5, as shown in Table 1 and FIG. 9, in Step S2, a pulse voltage Vlc of ±12 V is applied to the cholesteric liquid crystal to maintain the level 7. Then, in the next Step S3, a pulse voltage Vlc of ±24 V is applied to the cholesteric liquid crystal for a time of 1.5 ms to change the state of the cholesteric liquid crystal close to the focal conic state by a predetermined amount. In Step S3, since a pulse voltage Vlc of ±24 V is applied to the cholesteric liquid crystal for a time that is 1.5 times longer than that in Step S4, the grayscale level 5 that is one level lower than the level 6 shown in FIG. 8 is obtained. Then, in the next Step S4, a pulse voltage Vlc of ±12 V is applied to the cholesteric liquid crystal to maintain the level 5.

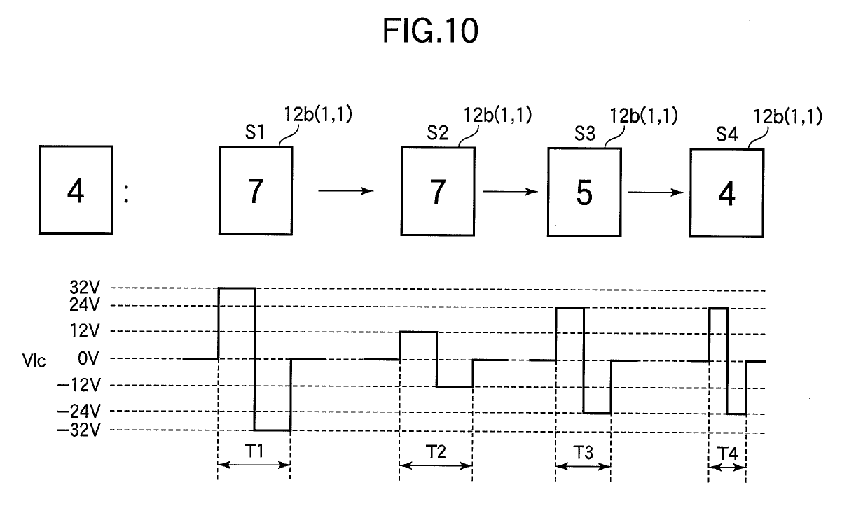

In order to make the grayscale of the B pixel 12b(1, 1) at level 4, as shown in Table 1 and FIG. 10, in Step S2, a pulse voltage Vlc of ±12 V is applied to the cholesteric liquid crystal to maintain the level 7. Then, in the next Step S3, a pulse voltage Vlc of ±24 V is applied to the cholesteric liquid crystal for a time of 1.5 ms to change the cholesteric liquid crystal to grayscale level 5 that is two levels lower than the level 7. In the next Step S4, a pulse voltage Vlc of ±24 V is applied to the cholesteric liquid crystal for a time of 1.0 ms to change the state of the cholesteric liquid crystal further close to the focal conic state, thereby obtaining the grayscale level 4 that is one level lower than the level 5.

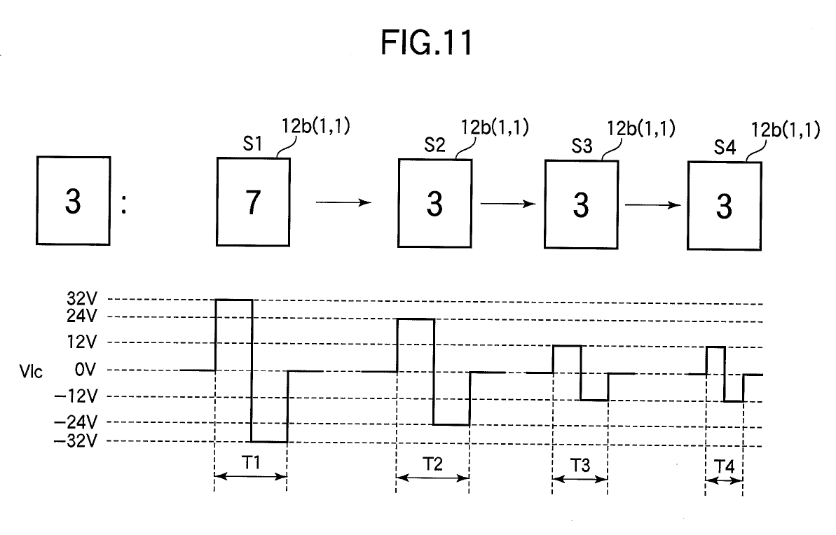

In order to make the grayscale of the B pixel 12b(1, 1) at level 3, as shown in Table 1 and FIG. 11, in Step S2, a pulse voltage Vlc of ±24 V is applied to the cholesteric liquid crystal for a time of 2.0 ms. In this way, the cholesteric liquid crystal is greatly changed from the planar state (level 7) close to the focal conic state, and the grayscale level 3 that is four levels lower than the grayscale level 7 is obtained. Since the grayscale level 3 is obtained in Step S2, a pulse voltage Vlc of ±12 V for maintaining the previous state is applied to the cholesteric liquid crystal to maintain the grayscale level 3 in Steps S3 and S4.

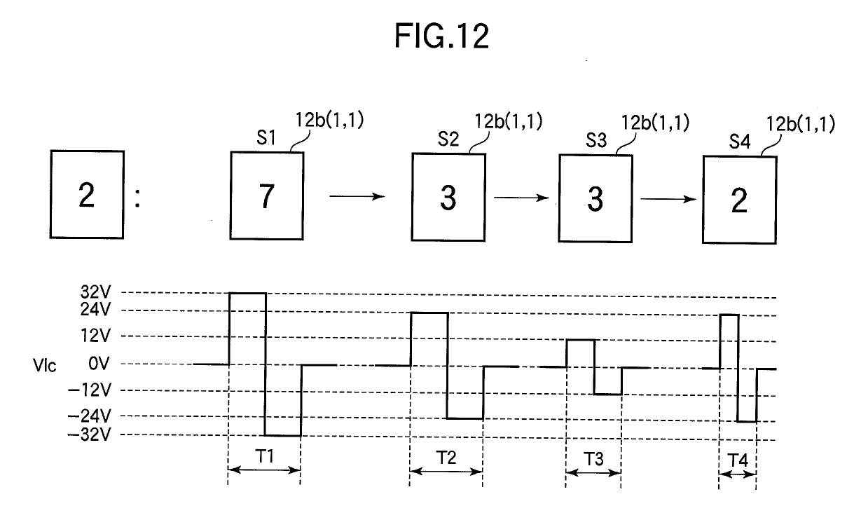

In order to make the grayscale of the B pixel 12b(1, 1) at level 2, as shown in Table 1 and FIG. 12, in Step S2, a pulse voltage Vlc of ±24 V is applied to the cholesteric liquid crystal for a time of 2.0 ms. In this way, the grayscale level 3 is obtained. Then, in the next Step S3, a pulse voltage Vlc of ±12 V for maintaining the previous state is applied to the cholesteric liquid crystal to maintain the grayscale level 3. In the next Step S4, a pulse voltage Vlc of ±24 V is applied to the cholesteric liquid crystal for a time of 1.0 ms to further change the state of the cholesteric liquid crystal close to the focal conic state, thereby obtaining the grayscale level 2 that is one level lower than the level 3.

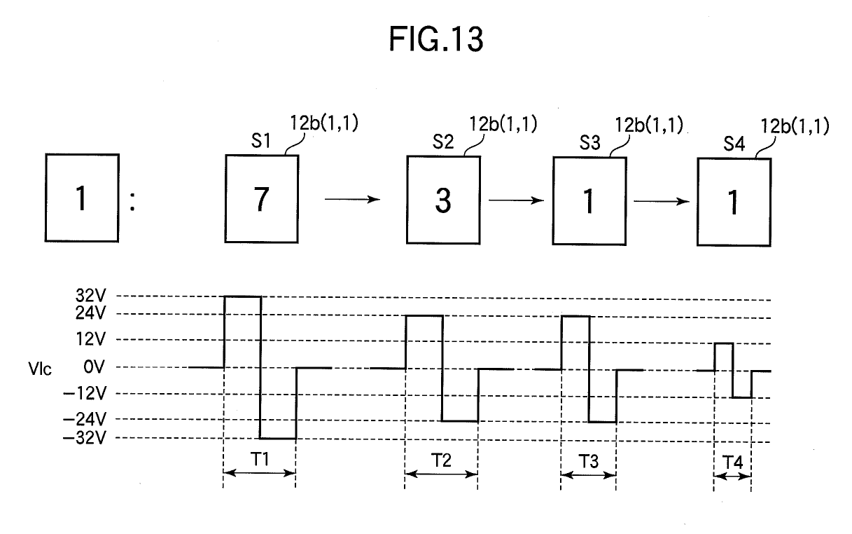

In order to make the grayscale of the B pixel 12b(1, 1) at level 1, as shown in Table 1 and FIG. 13, in Step S2, a pulse voltage Vlc of ±24 V is applied to the cholesteric liquid crystal for a time of 2.0 ms, thereby obtaining the grayscale level 3. Then, in the next Step S3, a pulse voltage Vlc of ±24 V is applied to the cholesteric liquid crystal for a time of 1.5 ms, thereby obtaining the grayscale level 1 that is two levels lower than the grayscale level 3. In Step S4, a pulse voltage Vlc of ±12 V for maintaining the previous state is applied to the cholesteric liquid crystal to maintain the grayscale level 1, thereby making the grayscale of the pixel at level 1.

In order to make the grayscale of the B pixel 12b(1, 1) at level 0 (black), as shown in Table 1 and FIG. 14, in Steps S2 to S4, a pulse voltage Vlc of ±24 V is applied to the cholesteric liquid crystal to change the cholesteric liquid crystal to the focal conic state and maintain the focal conic state.

During a non-driving period between steps, as described with reference to FIG. 4, a pulse voltage Vlc of ±4 V or ±8 V may be applied to the cholesteric liquid crystal.

In the multi-tone display method according to this embodiment, a pulse voltage Vlc is also repeatedly applied plural times to make the pixel in a pure black state (level 0). When a pulse voltage is applied only one time, light black is likely to be obtained due to weak scatter reflection. However, according to this embodiment, it is possible to perform high-contrast display with deep black. In addition, since a low pulse voltage is used, it is possible to stably prevent crosstalk in a non-selection region.

In this embodiment, display is performed at 8 grayscale levels. However, it is possible to perform display at 16 or more grayscale levels by increasing the number of driving times (the number of steps). Whenever the number of driving times is increased one by one, the number of grayscale levels can be increased two times. For example, when the number of driving times is 5, it is possible to display 16 grayscale levels. When the number of driving times is 7, it is possible to display 64 grayscale levels. When the number of driving times is 1, it is possible to display 2 grayscale levels. As such, in the multi-tone display method according to this embodiment, the number of driving times depends on the number of grayscale levels.

It is possible to display 512 colors (in the case of 8 grayscale levels) or more (multi-tone display) on the pixel 12(1, 1), which is a laminate of three B, G, and R pixels 12b(1, 1), 12g(1, 1), and 12r(1, 1), by driving the green (G) pixel 12g(1, 1) and the red (R) pixel 12r(1, 1) by the same method as that driving the B pixel 12b(1, 1). In addition, it is possible to output display data to all of the pixels 12(1, 1) to 12(240, 320) by performing so-called line sequential driving (line sequential scanning) on the first to two hundred fortieth row scanning electrodes 17b, 17g, and 17r and rewriting a data voltages of each of the data electrodes 19b, 19g, and 19r one by one of rows a predetermined number of driving times, thereby displaying one frame of color image (display screen).

In the above-described multi-tone display method, it is possible to perform multi-tone display using binary inexpensive general-purpose drivers, without using a specific driver IC capable of generating a multi-level driving waveform. Therefore, it is possible to perform multi-tone (multi-color) display at a low cost.

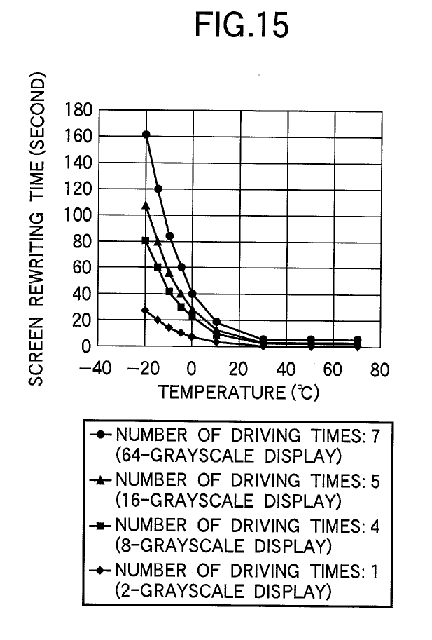

FIG. 15 is a graph illustrating experimental results showing the relationship between a screen rewriting time and the temperature of the liquid crystal display element 1 when the multi-tone display method is used. In the graph, the horizontal axis indicates the temperature (° C.) of the liquid crystal display element 1, and the vertical axis indicates the screen rewriting time (second) of the liquid crystal display element 1. In the experimental example of the invention, the outside air temperature around the liquid crystal display element 1, which is substantially equal to the temperature of the liquid crystal display element 1, is measured and used as the temperature of the liquid crystal display element 1. In FIG. 15, a curved line linking symbols ♦ indicates the relationship between the screen rewriting time and the temperature when the number of driving times (the number of steps) for multi-tone display is 1 (2-grayscale display). Similarly, a curved line linking symbols ▪ indicates the relationship between the screen rewriting time and the temperature when the number of driving times for multi-tone display is 4 (8-grayscale display). A curved line linking symbols ▴ indicates the relationship between the screen rewriting time and the temperature when the number of driving times for multi-tone display is 5 (16-grayscale display). A curved line linking symbols indicates the relationship between the screen rewriting time and the temperature when the number of driving times for multi-tone display is 7 (64-grayscale display).

As shown in FIG. 15, as the number of driving times (the number of grayscale levels) increases, the number of steps for multi-tone display (for example, four steps, that is, Steps S1 to S4 shown in FIGS. 7 to 14 in the case of 8-grayscale display) increases, and the time required to scan one row increases during a line sequential driving (line sequential scanning) operation, which results in an increase in the screen rewriting time.

The response characteristics of the cholesteric liquid crystal are lowered when the temperature is reduced. Therefore, as the temperature is reduced, the width of a driving voltage pulse (the time for which a pulse voltage is applied. In the case of 8-grayscale display, the application times T1 to T4 shown in FIGS. 7 to 14) is increased. It is possible to drive the cholesteric liquid crystal for a long time by increasing the width of the driving voltage pulse. Therefore, even when the response characteristics are lowered at a low temperature, it is possible to display a desired grayscale. However, as shown in FIG. 15, as the temperature is reduced, the screen rewriting time is increased.

In the above-mentioned multi-tone display method, when the number of driving times is large, the operation of the liquid crystal display element 1 may cause problems at a low temperature. For example, when the temperature is 10° C., the liquid crystal display element 1 completes screen rewriting within 20 seconds, regardless the number of driving times (the number of grayscale levels), and there is no great difference in the screen rewriting time. However, at the low temperature, there is a great difference in the screen rewriting time according to the number of driving times. For example, at a temperature of −20° C., the screen rewriting time is about 30 seconds when the number of driving times is 1 (2-grayscale display). The screen rewriting time is about 80 seconds when the number of driving times is 4 (8-grayscale display). The screen rewriting time is about 110 seconds when the number of driving times is 5 (16-grayscale display). The screen rewriting time is about 160 seconds when the number of driving times is 7 (64-grayscale display). When the number of driving times is large, a very long time is required for screen rewriting at the low temperature.

Therefore, as the number of driving times is increased, the quality of a displayed image can be improved. However, at the low temperature, the screen rewriting time is increased, which is impractical. When the number of driving times is 7 (64-grayscale display), the screen rewriting time of the liquid crystal display element 1 is about 10 seconds at a temperature of 20° C., about 20 seconds at a temperature of 10° C., about 30 seconds at a temperature of 5° C., about 40 seconds at a temperature of 0° C., about 60 seconds at a temperature of −5° C., about 85 seconds at a temperature of −10° C., about 120 seconds at a temperature of −15° C., and about 160 seconds at a temperature of −20° C. At a temperature of 5° C. or less, the screen rewriting is not completed after 30 seconds have elapsed after the screen rewriting started, and thus it is difficult to display a high-quality image. Therefore, when the number of times is set to 7 and the screen rewriting is set to be performed within 30 seconds, the liquid crystal display element 1 can be operated only in a temperature range of 5 to 70° C.

Meanwhile, when the number of times is small, for example, 1 (2-grayscale display), the liquid crystal display element 1 can rewrite a screen in a short time. Therefore, the number of grayscale levels is small, which makes it difficult to display a high-quality image.

In order to solve the above problems, in the method of driving the liquid crystal display element 1 according to this embodiment, as the temperature is reduced, the number of driving times (the number of grayscale levels) is gradually decreased. For example, when the screen rewriting time is set within 30 seconds, the number of driving times is set to 7 (64-grayscale display) at a temperature of 5° C. to 70° C. The number of driving times is set to 5 (16-grayscale display) at a temperature of 0° C. to 5° C., and the number of driving times is set to 4 (8-grayscale display) at a temperature of −5° C. to 0° C. The number of driving times is set to 1 (2-grayscale display) at a temperature of −20° C. to −5° C. In this way, the liquid crystal display element 1 can operate at a temperature of −20° C. to 70° C. even when the screen rewriting time is set within 30 seconds.

For example, when the screen rewriting time is set within 60 seconds, the number of driving times is set to 7 (64-grayscale display) at a temperature of −5° C. to 70° C. The number of driving times is set to 5 (16-grayscale display) at a temperature of −10° C. to −5° C., and the number of driving times is set to 4 (8-grayscale display) at a temperature of −15° C. to −10° C. The number of driving times is set to 1 (2-grayscale display) at a temperature of −20° C. to −15° C. In this way, the liquid crystal display element 1 can operate at a temperature of −20° C. to 70° C. even when the screen rewriting time is set within 60 seconds.

As described above, as the temperature is reduced, the number of driving times (the number of grayscale levels) is gradually decreased. Therefore, it is possible to reduce the screen rewriting time at the low temperature, and thus it is possible to obtain a wide operation temperature range even when the screen rewriting time is limited in a predetermined range. In addition, when the temperature is not low, it is possible to display a high grayscale level image, for example, a 64-grayscale image, thus displaying a high quality image.

Table 2 shows the above-mentioned driving patterns. Table 2 shows the temperature (° C.) range in which the number of driving times (1, 4, 5, and 7) and the number of grayscale levels (2, 8, 16, and 64 grayscale levels) corresponding thereto are used when the screen rewriting time is set within 30 seconds (screen rewriting time: 30 seconds) and within 60 second (screen rewriting time: 60 seconds).

TABLE 2

| Number of | | | |
|---|---|---|---|
| driving | Number of grayscale | Screen rewriting | Screen rewriting |
| times | levels | time 30 seconds | time 60 seconds |
| 1 | 2 grayscale levels | −20 to −5° C. | −20 to −15° C. |
| 4 | 8 grayscale levels | −5 to 0° C. | −15 to −10° C. |
| 5 | 16 grayscale levels | 0 to 5° C. | −10 to −5° C. |
| 7 | 64 grayscale levels | 5 to 70° C. | −5 to 70° C. |

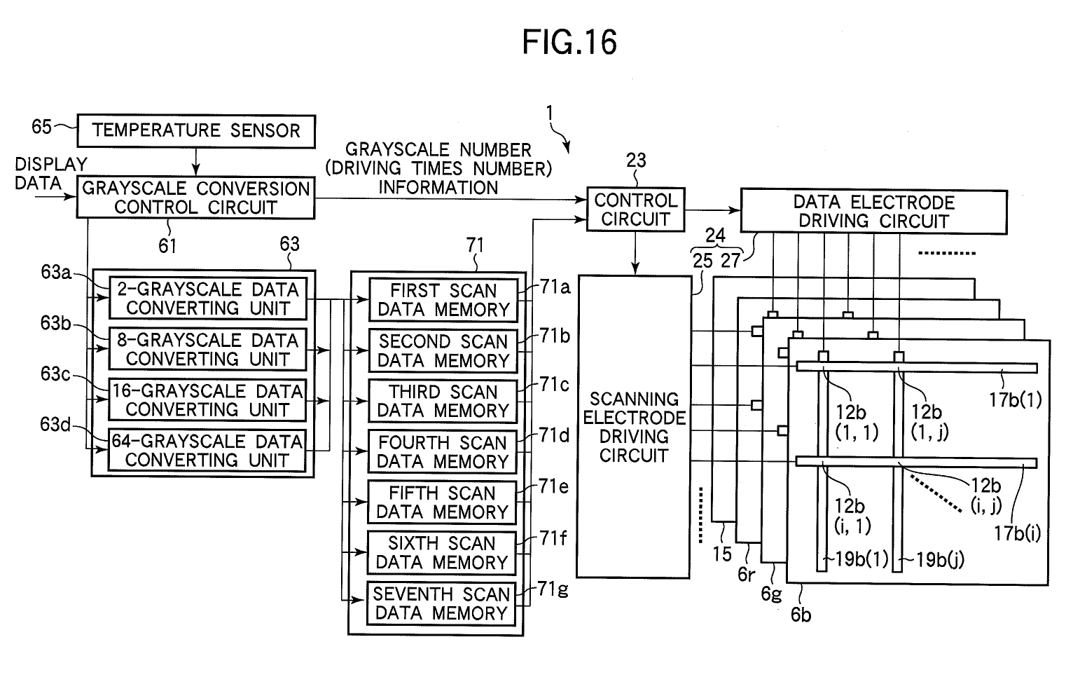

Next, an image processing method and a driving method of the liquid crystal display element 1 when the number of driving times (the number of grayscale levels) varies on the basis of a variation in temperature will be described with reference to FIG. 16. FIG. 16 is a system block diagram illustrating the image processing method of the liquid crystal display element 1 according to this embodiment. As shown in FIG. 16, the liquid crystal display element 1 includes: the B, G, and R display units 6b, 6g, and 6r that have the liquid crystal layers 3b, 3g, and 3r (not shown in FIG. 16) which are driven a predetermined number of times to obtain desired grayscales, and display images on the basis of the grayscales; a grayscale conversion control unit (driving control unit) 61 that can determine a driving method on the basis of an external environment; and the driving unit 24 that drives the liquid crystal layers 3b, 3g, and 3r using the determined driving method. As will be described below, the grayscale conversion control unit 61 determines the number of times to drive the liquid crystal layers 3b, 3g, and 3r, and the driving unit 24 drives the liquid crystal layer 3b, 3g, and 3r the determined number of times to make the liquid crystal layers 3b, 3g, and 3r at grayscale levels corresponding to an external environment.

The grayscale conversion control unit 61 is connected to a temperature sensor (temperature detecting unit) 65 that detects the outside air temperature (external environment) around the liquid crystal display element 1. The temperature sensor 65 outputs the measured outside air temperature to the grayscale conversion control unit 61. The grayscale conversion control unit 61 determines the number of grayscale levels and the number of driving times corresponding to the number of grayscale levels, on the basis of the outside air temperature. The temperature range in which the number of grayscale levels and the number of driving times are used is set as shown in Table 2 on the basis of a desired screen rewriting time.

Display data for each pixel is input from an external system (not shown) to the grayscale conversion control unit 61. In this embodiment, the display data is 6 bits for each pixel (the number of grayscale levels: 64). For example, 6-bit display data of the B pixel 12b(i, j), 6-bit display data of the G pixel 12g(i, j), and 6-bit display data of the R pixel 12r(i, j) of the pixel 12(i, j) (where i is an integer satisfying 1≦i≦240 and j is an integer satisfying 1≦j≦320) are sequentially input from the external system to the grayscale conversion control unit 61 in synchronization with a predetermined clock signal.

A data converting unit 63 is connected to the grayscale conversion control unit 61. The data converting unit 63 converts the 64-grayscale display data (grayscale value) that is sequentially input from the external system into driving voltage data corresponding to the number of driving times determined by the grayscale conversion control unit 61, on the basis of the measured result by the temperature sensor 65 and the determined number of driving times. The data converting unit 63 includes a 2-grayscale data converting unit 63a, an 8-grayscale data converting unit 63b, a 16-grayscale data converting unit 63c, and a 64-grayscale data converting unit 63d. The 2-grayscale data converting unit 63a is used when the number of driving times determined by the grayscale conversion control unit 61 is 1 (2-grayscale display). Similarly, the 8-grayscale, 16-grayscale, and 64-grayscale data converting units 63b, 63c, and 63d are used when the number of driving times is 4 (8-grayscale display), 5 (16-grayscale display), and 7 (64-grayscale display), respectively.

The grayscale conversion control circuit 61 selects any one of the data converting units 63a to 63d of the data converting unit 63 corresponding to the determined number of grayscale levels and the determined number of driving times, and outputs display data to the selected one of the data converting units 63a to 63d.

A scan data memory 71 is connected to the data converting unit 63. The scan data memory 71 includes first to seventh scan data memories 71a to 71g. The scan data memory 71 temporarily stores the driving voltage data generated by the data converting unit 63. In this embodiment, the first to seventh scan data memories 71a to 71g can store 240×320×3 driving voltage data corresponding to 240 rows×320 columns B pixels 12b(1, 1) to 12b(240, 320), 240 rows×320 columns G pixels 12g(1, 1) to 12g(240, 320), and 240 rows×320 columns R pixels 12r(1, 1) to 12r(240, 320), respectively. The scan data memory 71 is connected to the control circuit 23.

Next, a description will be made of an image processing method and a driving method for displaying an image on the B display unit 6b assuming that the grayscale conversion control unit 61 determines to perform driving times four times on the basis of external temperature information and only display data for the B pixel 12b(i, j) is input from the external system for clarity of description. The grayscale conversion control circuit 61 outputs 6-bit display data of the B pixel 12(i, j) to the 8-grayscale data converting unit 63b. The 8-grayscale data converting unit 63b converts the display data into four driving voltage data for the B pixel 12b(i, j), that is, first driving voltage data Dbs1(i, j), second driving voltage data Dbs2(i, j), third driving voltage data Dbs3(i, j), and fourth driving voltage data Dbs4(i, j). The first to fourth driving voltage data Dbs1(i, j) to Dbs4(i, j) are binary data that designates the level of the pulse voltage Vlc applied in Steps S1 to S4 shown in FIGS. 7 to 14.

As such, the 8-grayscale data converting unit 63b converts 64-grayscale display data into 8-grayscale display data. When display data is converted into lower grayscale display data, image quality is likely to deteriorate. For example, an ordered dither method, an error diffusion method, or a blue noise mask method is used as an algorithm for image processing in the 8-grayscale data converting unit 63b. Any one of these algorithms can be used to prevent the deterioration of the quality of a displayed image even when the number of grayscale levels is small. In addition, a threshold method may be used as an algorithm for grayscale conversion. These algorithms are used for the image processing of the 2-grayscale and 16-grayscale data converting units 63a and 63c, which will be described below.

The generated first driving voltage data Dbs1(i, j) is stored at an address B1(i, j) of the first scan data memory 71a. Similarly, the generated second to fourth driving voltage data Dbs2(i, j) to Dbs4(i, j) are stored at addresses B2(i, j) to B4(i, j) of the second to fourth scan data memories 71b to 71d, respectively.

The above operation is repeatedly performed on the B pixels 12b(1, 1) to 12b(240, 320) to store the first driving voltage data Dbs1(1, 1) to Dbs1(240, 320) at the addresses B1(1, 1) to B1(240, 320) of the first scan data memory 71a.

Similarly, the second driving voltage data Dbs2(1, 1) to Dbs2(240, 320) are stored at the addresses B2(1, 1) to B2(240, 320) of the second scan data memory 71b. The third driving voltage data Dbs3(1, 1) to Dbs3(240, 320) are stored at the addresses B3(1, 1) to B3(240, 320) of the third scan data memory 71c. The fourth driving voltage data Dbs4(1, 1) to Dbs4(240, 320) are stored at the addresses B4(1, 1) to B4(240, 320) of the fourth scan data memory 71d.

Grayscale number (driving times number) information indicating that the number of grayscale levels is 8 (the number of driving times is 4) is input from the grayscale conversion control unit 61 to the control circuit 23. The control circuit 23 sequentially receives the first driving voltage data Dbs1(i, 1) to Dbs1(i, 320) from the first scan data memory 71a on the basis of the grayscale number (driving times number) information, and sequentially outputs the data to the data electrode driving circuit 27. The data electrode driving circuit 27 receives the first driving voltage data corresponding to one scanning electrode, latches the data, and simultaneously outputs it to 320 data electrodes 19b(1) to 19b(320). In synchronization with this operation, the scanning electrode driving circuit 25 selects an i-th row scanning electrode 17b(i) and outputs a predetermined scanning signal voltage. In this way, Step S1 shown in FIGS. 7 to 14 is performed on the B pixels 12b(i, 1) to 12b(i, 320) on the i-th row scanning electrode 17b(i). This operation is repeatedly performed on the first to two hundred fortieth row scanning electrodes 17b(1) to 17b(240) to execute Step S1 on all of the B pixels 12b(1, 1) to 12b(240, 320).

Then, the control circuit 23 sequentially receives the second driving voltage data Dbs2(i, 1) to Dbs2(i, 320) from the second scan data memory 71b, and sequentially outputs the data to the data electrode driving circuit 27. The data electrode driving circuit 27 receives the second driving voltage data corresponding to one scanning electrode, latches the data, and simultaneously outputs it to 320 data electrodes 19b(i, 1) to 19b(i, 320). In synchronization with this operation, the scanning electrode driving circuit 25 selects an i-th row scanning electrode 17b(i) and outputs a predetermined scanning signal voltage. In this way, Step S2 shown in FIGS. 7 to 14 is performed on the B pixels 12b(i, 1) to 12b(i, 320) on the i-th row scanning electrode 17b(i). This operation is repeatedly performed on the first to two hundred fortieth row scanning electrodes 17b(1) to 17b(240) to execute Step S2 on all of the B pixels 12b(1, 1) to 12b(240, 320).

Similarly, the third driving voltage data Dbs3 is written to 320 B pixels 17b in the i-th row, and Step S3 is performed. Then, the fourth driving voltage data Dbs4 is written to 320 B pixels 17b in the i-th row, and Step S4 is performed.

As described above, the control circuit 23 controls the driving unit 24 (the scanning electrode driving circuit 25 and the data electrode driving circuit 27) on the basis of the grayscale number (driving times number) information and the acquired first to fourth driving voltage data. The driving unit 24 performs Steps S1 to S4 shown in FIGS. 7 to 14 on the B pixels 12b(1, 1) to 12b(240, 320) on the basis of a predetermined signal output from the control circuit 23. In this way, any one of the grayscale levels 7 (blue) to 0 is displayed on the B pixels 12b(1, 1) to 12b(240, 320), and the B display unit 6b displays an 8-grayscale-level image.

The same process as described above is performed on the G and R display units 6g and 6r to output the first to fourth driving voltage data to all of the pixels 12(1, 1) to 12(240, 320), thereby displaying one frame of image (display screen).

When the number of driving times is 1, the grayscale conversion control circuit 61 outputs display data to the 2-grayscale data converting unit 63a. The 2-grayscale data converting unit 63a converts the display data to generate a piece of driving voltage data (the first driving voltage data) for one pixel 12b. The first driving voltage data is binary data that designates whether the pulse voltage Vlc applied Step S1 shown in FIGS. 7 to 14 is ±32 V or ±24 V. The generated first driving voltage data is stored in the first scan data memory 71a.

When the number of driving times is 5, the grayscale conversion control circuit 61 outputs display data to the 16-grayscale data converting unit 63c. The 16-grayscale data converting unit 63c converts the display data to generate five driving voltage data (the first to fifth driving voltage data). The first to fifth driving voltage data are binary data that designate the pulse voltage Vlc applied in five Steps S1 to S5 when the number of driving times is 5. The generated first to fifth driving voltage data are stored in the first to fifth scan data memories 71a to 71e, respectively.

When the number of driving times is 7, the grayscale conversion control circuit 61 outputs display data to the 64-grayscale data converting unit 63d. The 64-grayscale data converting unit 63d converts the display data to generate seven driving voltage data (the first to seventh driving voltage data). The first to seventh driving voltage data are binary data that designate the pulse voltage Vlc applied in seven Steps S1 to S7 when the number of driving times is 7. The generated first to seventh driving voltage data are stored in the first to seventh scan data memories 71a to 71g, respectively.

### COMPARATIVE EXAMPLE

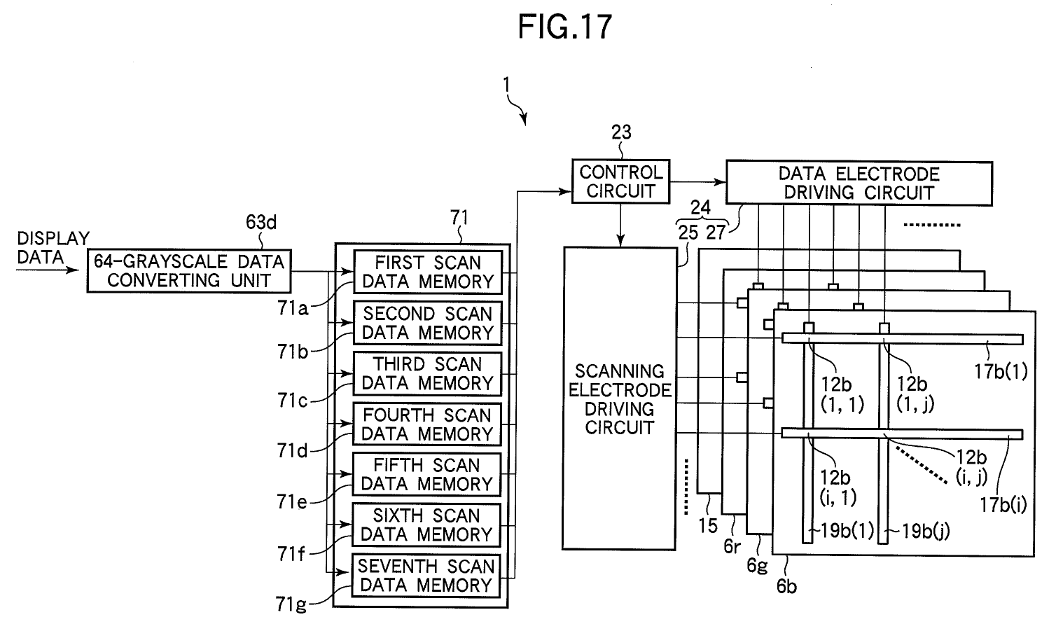

FIG. 17 is a system block diagram illustrating an image processing method of the liquid crystal display element 1 according to the related art, which is a comparative example of the image processing method of the liquid crystal display element 1 according to this embodiment. As shown in FIG. 17, when the image processing method according to the related art is used, the liquid crystal display element 1 does not include the grayscale conversion control circuit 61, but includes only the 64-grayscale data converting unit 63d as a data converting unit.

Therefore, display data input to the 64-grayscale data converting unit 63d is converted into seven driving voltage data (the first to seventh driving voltage data) for one B pixel 12b. The number of driving times is fixed to 7 without depending on the temperature. In the image processing method according to the related art, when screen rewriting is set within 30 seconds, some of the pulse voltages Vlc corresponding to the first to seventh driving voltage data are not applied to the B, G, and R pixels 12b, 12g, and 12r at a temperature of 5° C. or less. As a result, a whiten image with some halftone pixels deleted is displayed, resulting in the deterioration of image quality.

Next, an example of a method of manufacturing the liquid crystal display element 1 will be simply described.

ITO transparent electrodes are formed on two polycarbonate (PC) film substrates each having a size of 10 (cm)×8 (cm) and then patterned by etching to form strip-shaped electrodes (the scanning electrodes 17 and the data electrodes 19) at a pitch of 0.24 mm. Then, strip-shaped electrodes are formed on two PC film substrates so as to support a 320×240 QVGA resolution. Then, a polyimide-based alignment film material is applied with a thickness of about 700 Å on the strip-shaped transparent electrodes 17 and 19 of the two PC film substrates 7 and 9 by a spin coating method. Then, the two PC film substrates 7 and 9 having the alignment film material applied thereon are baked in an oven at a temperature of 90° C. for one hour, thereby forming alignment films. Subsequently, an epoxy-based sealing material 21 is applied at the edge of one of the PC film substrates 7 and 9 by a dispenser to form a wall having a predetermined height.

Then, spacers (produced by Sekisui Fine Chemicals Co., Ltd.) having a diameter of 4 μm are dispersed in the other substrate of the two PC film substrates 9 and 7. Then, the two PC film substrates 7 and 9 are bonded to each other and then heated at a temperature of 160° C. for one hour to harden the sealing material 21. Subsequently, B cholesteric liquid crystal LCb is injected by a vacuum injection method and an inlet for liquid crystal injection is sealed by an epoxy-based sealing material, thereby manufacturing the B display unit 6b. The G and R display units 6g and 6r are manufactured by the same method as described above.

Then, as shown in FIG. 2, the B, G, and R display units 6b, 6g, and 6r are sequentially laminated on the display surface in this order. Subsequently, the visible light absorbing layer 15 is provided on the rear surface of the lower substrate 9r of the R display unit 6r. Then, a general-purpose STN driver IC having a TCP (tape carrier package) structure is connected to the terminals of the scanning electrodes 17 and the terminals of the data electrodes 19 of the laminated B, G, and R display units 6b, 6g, and 6r by contact bonding, and then a power supply circuit and the control circuit 23 are connected thereto. In this way, the liquid crystal display element 1 capable of supporting a QVGA resolution is manufactured. Although not shown in the drawings, an input/output device (not shown) and a control device (not shown) for controlling the overall operation of the liquid crystal display element 1 are provided in the liquid crystal display element 1, thereby completing an electronic paper.

As described above, according to this embodiment, as the temperature is reduced, the number of driving times (the number of grayscale levels) is gradually decreased, and thus it is possible to reduce the screen rewriting time at a low temperature. Therefore, it is possible to display an image in a short time during screen rewriting even at a low temperature. In addition, it is possible to obtain a wide operation temperature even when the screen rewriting time is limited to a predetermined range.

### Second Embodiment

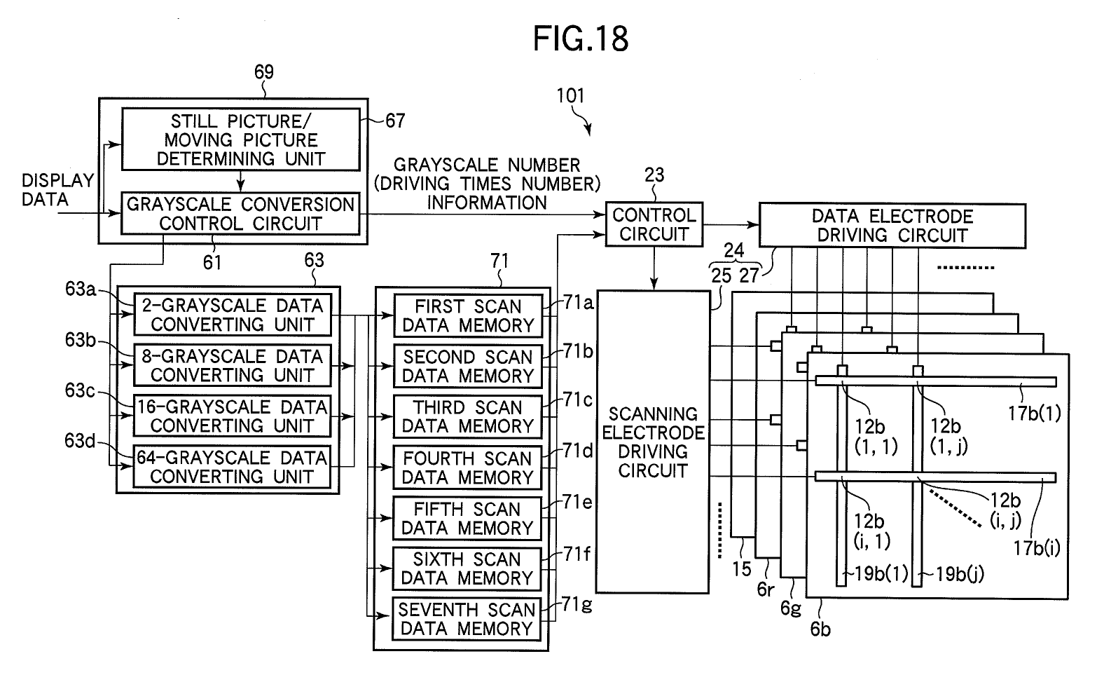

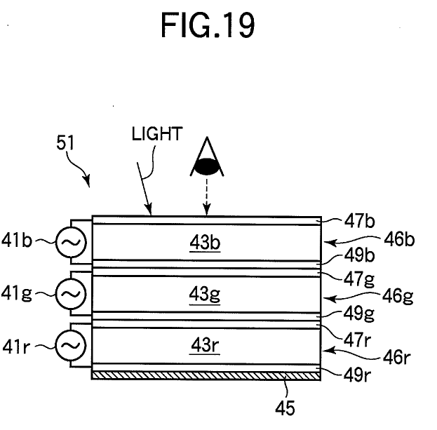

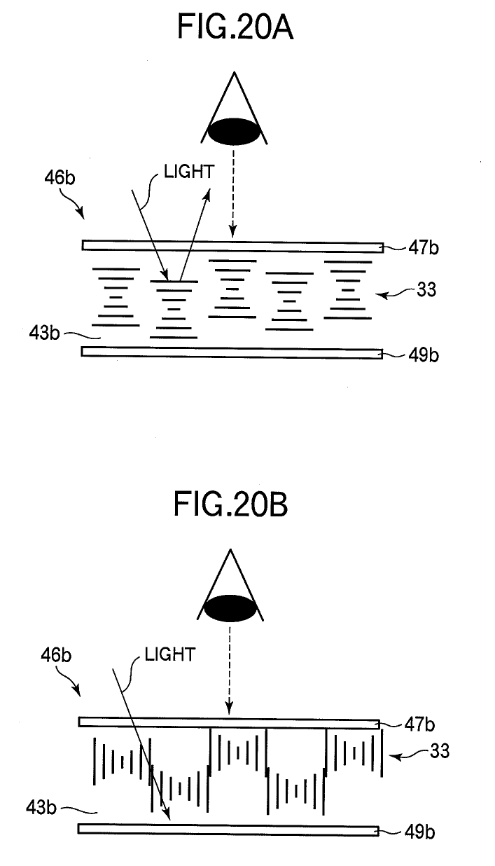

A liquid crystal display element, a method of driving the same, and an electronic paper including the same according to a second embodiment will be described with reference to FIG. 18. FIG. 18 is a system block diagram illustrating an image processing method of a liquid crystal display element 101 according to this embodiment. The liquid crystal display element 101 according to this embodiment is characterized in that it includes a still picture/moving picture determining unit 67 instead of the temperature sensor 65 of the liquid crystal display element 1 according to the first embodiment.

A method of driving the liquid crystal display element 101 according to this embodiment is characterized in that it determines whether an image is a still picture or a moving picture to decide the number of driving times, unlike the first embodiment in which the driving method of the liquid crystal display element 1 determines the number of driving times on the basis of the outside air temperature around the liquid crystal display element 1. In the following description, components having the same functions and operations as those in the first embodiment are denoted by the same reference numerals, and a description thereof will be omitted.

As shown in FIG. 18, the liquid crystal display element 101 includes: B, G, and R display units 6b, 6g, and 6r that have liquid crystal layers (liquid crystal) 3b, 3g, and 3r (not shown in FIG. 18) which are driven a predetermined number of times to obtain desired grayscales, and display images on the basis of the grayscales; a driving times number determining unit (driving control unit) 69 that determines the number of driving times (driving method) on the basis of whether an image is a still picture or a moving picture (external environment); and a driving unit 24 that drives the liquid crystal layers 3b, 3g, and 3r by the determined number of driving times. The driving times number determining unit 69 includes a grayscale conversion control unit 61 and a still picture/moving picture determining unit 67. The liquid crystal display element 101 does not include the temperature sensor 65. The structure of the liquid crystal display element 101 is the same as that of the liquid crystal display element 1 according to the first embodiment except for the above. Therefore, a description thereof will be omitted.

The still picture/moving picture determining unit 67 is connected to the grayscale conversion control unit 61. Display data is input to the grayscale conversion control circuit 61 and the still picture/moving picture determining unit 67. The still picture/moving picture determining unit 67 performs subtraction or division on the input time-series grayscale data for each of the pixels 12b, 12g, and 12r to determine whether the display data is a still picture or a moving picture, and outputs information (still picture/moving picture information) indicating whether the display data is a still picture or a moving picture to the grayscale conversion control unit 61.

The grayscale conversion control unit 61 determines the number of grayscale levels and the number of driving times determined by the number of grayscales, on the basis of the still picture/moving picture information output from the still picture/moving picture determining unit 67. For example, when the display data is a still picture, the number of driving times is set to 7 (64-grayscale display). When the display data is a moving picture, the number of driving times is set to 4 (8-grayscale display). The number of driving times and the number of grayscale levels are not limited thereto.

The grayscale conversion control unit 61 selects the 8-grayscale display data converting unit 63b or the 64-grayscale display data converting unit 63d corresponding to the determined number of grayscale levels and the determined number of driving times from the data converting unit 63, and outputs display data to the data converting unit 63b or 63d. The operations of the data converting unit 63, the scan data memory 71, the control circuit 23, and the driving unit 24 are the same as those in the image processing method and the driving method of the liquid crystal display 1 shown in FIG. 16, and thus a description thereof will be omitted.

When the display data is a moving picture, 64-grayscale display data is converted into 8-grayscale display data having less grayscale. In order to display the moving picture, the data converting unit 63b uses, for example, an ordered dither method, an error diffusion method, or a blue noise mask method as an algorithm for image processing. These algorithms can prevent the deterioration of the quality of a displayed image even when the number of grayscale levels is small. In addition, a threshold method may be used as an algorithm for grayscale conversion.

According to this embodiment, it is determined whether an image is a still picture or a moving picture, and the number of driving times when the image is a moving picture is set to be smaller than that when the image is a still picture. Therefore, it is possible to reduce the screen rewriting time when a moving picture is displayed.

The invention is not limited to the above-described embodiments, but various modifications and changes of the invention can be made.

In the above-described embodiments, a line sequential driving (line sequential scanning) method is used as an example of the driving method, but the invention is not limited thereto. For example, a dot sequential driving method may be used as the driving method.

In the above-described embodiments, a three-layer liquid crystal display element including the B, G, and R display units 6b, 6g, and 6r is used as an example, but the invention is not limited thereto. For example, the invention may be applied to a two-layer liquid crystal display element or a four-or-more-layer liquid crystal display element.

In the above-described embodiments, the liquid crystal display element including the display units 6b, 6g, and 6r respectively provided with the liquid crystal layers 3b, 3g, and 3r that reflect blue, green, and red light in the planar state is used as an example, but the invention is not limited thereto. For example, the invention may be applied to a liquid crystal display element that includes three display units having liquid crystal layers that reflect cyan, magenta, and yellow light in the planar state.

In the above-described embodiments, a passive matrix liquid crystal display element is used as an example, but the invention is not limited thereto. For example, the invention may be applied to an active matrix liquid crystal display element in which a switching element, such as a thin film transistor (TFT) or a diode, is provided in each pixel.

In the above-described embodiments, a plurality of frames (for example, four frames in the case of 8-grayscale display) form one image in order to perform grayscale display, but the invention is not limited thereto. For example, in the case of 8-grayscale display, during one frame period, the same scanning electrode 17 may be driven four times to perform Steps S1 to S4 on the pixels 12 on the scanning electrodes 17.

In the above-described embodiments, four driving times are performed to display 8 grayscale levels, but the invention is not limited thereto. The invention can be applied to a liquid crystal display element that displays a predetermined grayscale image by a predetermined number of driving times. For example, the invention can be applied to a driving method of a liquid crystal display element capable of displaying 8 grayscale levels by three driving times.

In the above-described embodiments, the number of driving times is 1, 4, 5, and 7, but the invention is not limited thereto. For example, two or three of the numbers of driving times may be used. In addition, the number of driving times may be, for example, 2, 3, or 6 (32-grayscale display).

In the first embodiment, the temperature sensor 65 measures the outside air temperature around the liquid crystal display element 1, but the invention is not limited thereto. The temperature sensor 65 may directly measure the temperature of the liquid crystal display element 1.

In the multi-tone display method described with reference to FIGS. 7 to 14, the application times (pulse widths) T1 to T4 of the pulse voltage Vlc applied in Steps S1 to S4 are different from each other to display 8 grayscale levels, but the invention is not limited thereto. Different pulse voltages Vlc may be applied in Steps S1 to S4 to display 8 grayscale levels.

What is claimed is:

1. A liquid crystal display element comprising:
a display unit that includes liquid crystal;
a driving control unit that can determine a driving method on the basis of an external environment; and
a driving unit that drives the liquid crystal using the determined driving method.

2. The liquid crystal display element according to claim 1,
wherein the driving control unit determines the number of driving times, and
the driving unit drives the liquid crystal the determined number of driving times to obtain a grayscale corresponding to the external environment.

3. The liquid crystal display element according to claim 2, further comprising:
a data converting unit that converts a grayscale value indicating the grayscale into driving voltage data corresponding to the number of driving times.

4. The liquid crystal display element according to claim 2, further comprising:
a temperature detecting unit that serves as a detector for detecting the external environment,
wherein the driving control unit determines the driving method on the basis of the temperature detected by the temperature detecting unit.

5. The liquid crystal display element according to claim 4,
wherein, if the number of driving times is D1 at a temperature T1 and the number of driving times is D2 at a temperature T2 (T2<T1), D1 is larger than D2.

6. The liquid crystal display element according to claim 5,
wherein, if the number of grayscale levels is G1 at the number of driving times D1 and the number of grayscale levels is G2 at the number of driving times D2, G1 is larger than G2.

7. The liquid crystal display element according to claim 2,
wherein the driving control unit determines whether an image is a still picture or a moving picture and determines the driving method.

8. The liquid crystal display element according to claim 7,
wherein, if the number of driving times is D3 when the image is the still picture and the number of driving times is D4 when the image is the moving picture, D3 is larger than D4.

9. The liquid crystal display element according to claim 1,
wherein the liquid crystal is cholesteric liquid crystal having a light reflecting state, a light transmitting state, and an intermediate state therebetween.

10. The liquid crystal display element according to claim 1,
wherein the display unit includes a pair of substrates that are opposite to each other with the liquid crystal sealed therebetween, and
a plurality of the display units are laminated to each other.

11. The liquid crystal display element according to claim 10,
wherein the plurality of display units include a first display unit that reflects blue light, a second display unit that reflects green light, and a third display unit that reflects red light, and
the first to third display units are laminated in this order from a display surface.

12. An electronic paper for displaying an image, comprising:
the liquid crystal display element according to claim 1.

13. A method of driving a liquid crystal display element, comprising:
determining the number of driving times to drive liquid crystal on the basis of an external environment;
driving the liquid crystal the determined number of driving times; and
displaying an image corresponding to a grayscale.

14. The method of driving a liquid crystal display element according to claim 13,
wherein the number of driving times is determined for each number of grayscale levels.

15. The method of driving a liquid crystal display element according to claim 13, further comprising:
converting a grayscale value indicating the grayscale into driving voltage data corresponding to the number of driving times.

16. The method of driving a liquid crystal display element according to claim 13,
wherein the number of driving times is determined on the basis of temperature.

17. The method of driving a liquid crystal display element according to claim 16,
wherein, if the number of driving times is D1 at a temperature T1 and the number of driving times is D2 at a temperature T2 (T2<T1), D1 is larger than D2.

18. The method of driving a liquid crystal display element according to claim 17,
wherein, if the number of grayscale levels is G1 at the number of driving times D1 and the number of grayscale levels is G2 at the number of driving times D2, G1 is larger than G2.

19. The method of driving a liquid crystal display element according to claim 13,
wherein the number of driving times is determined on the basis of whether an image is a still picture or a moving picture.

20. The method of driving a liquid crystal display element according to claim 19,
wherein, if the number of driving times is D3 when the image is the still picture and the number of driving times is when the image is the moving picture, D3 is larger than D4.
